(19) United States
(12) Patent Application Publication
(10) Pub. No.: US 2008/0247271 A1
(43) Pub. Date: Oct. 9, 2008

(54) SEISMIC SENSOR WITH RAIN NOISE SHIELD

(76) Inventor: David Monk, Houston, TX (US)

Correspondence Address: RICHARD A. FAGIN, P.O. BOX 1247, RICHMOND, TX, 77406-1247, US

(21) Appl. No.: 12/060,309

(22) Filed: Apr. 1, 2008

Related U.S. Application Data
(60) Provisional application No. 60/909,733, filed on Apr. 3, 2007.

(51) Int. Cl. G01V 1/24; G01V 1/16

(52) U.S. Cl. 367/37; 367/188

(57) ABSTRACT

A seismic sensor includes a seismic energy detector having a case configured to be affixed to the ground. A portion of the case above the ground surface is exposed. An energy distributing shield is affixed directly to the exposed portion of the case. A method for seismic data acquisition includes affixing a plurality of spaced apart seismic sensors to the ground surface. Each of the sensors includes a shield affixed directly to an exposed portion of the sensor. The shield is made from an energy distributing material. At selected times a seismic energy source is actuated. Signals generated by each of the seismic sensors are recorded individually.

### CROSS-REFERENCE TO RELATED APPLICATIONS

Priority is claimed from U.S. Provisional Application No. 60/909,733 filed on Apr. 3, 2007.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic surveying. More particularly, the invention relates to devices for reducing random noise in geophone-type seismic surveys such as caused by rain.

2. Background Art

Land-based seismic surveying includes deploying an array of seismic particle motion detectors, typically geophones, in a selected pattern on or near the surface of the Earth, and actuating a seismic energy source deployed near the array. Seismic energy from the source travels through the Earth's subsurface until it is reflected by acoustic impedance boundaries therein. Reflected seismic energy travels upwardly to the Earth's surface where it is detected by the geophones in the array. The seismic energy detected by the geophones is converted into signals, typically electrical voltages. A recording is made of the voltage signals generated by the geophones in the array, typically indexed with respect to time of actuation of the source, and such recordings are analyzed to determine structure, mineral composition and fluid content of the rock formations in the Earth's subsurface, among other parameters.

It is known in the art to deploy particle motion sensors, including geophones such that subsets of the sensors in the array are electrically connected in series or parallel to minimize the effects or certain types of noise, for example, coherent noise such as “ground roll” and incoherent noise such as that caused by rain. The principle on which such connection is based is that signals intended to be detected, namely the seismic signals, will affect each of such interconnected sensors in substantially the same way, while random noise will affect each sensor differently. Series or parallel connection thus amounts to summing or stacking signals from the connected sensors, whereby the effects of random noise may be reduced. Coherent noise reduction may be achieved through the geometrical arrangement of the sensors within the array.

More recently, seismic surveys are being acquired that do not make use of such arrays of seismic particle motion sensors, or limit the number of such sensors in each connected subset. Such surveys are made to improve the spatial resolution of the seismic survey. However, such surveys may be more susceptible to the effects of random noise, such as rain striking the individual sensors if the recorded signal is from an individual sensor, and no random noise reduction has taken place through summation of signals from several sensors.

U.S. Pat. No. 7,255,196 issued to Coney et al. describes a system for shielding seismic sensors from wind noise. The disclosed shield in the '196 patent is configured to enclose a geophone and thereby protect it from harmful noise. The shield may comprise a rigid shell, a structural damping material, an acoustically absorptive material, and a compliant seal for coupling the shield to the ground or reference surface.

### SUMMARY OF THE INVENTION

One aspect of the invention is a seismic sensor. According to this aspect of the invention, a seismic sensor includes a seismic energy detector having a case configured to be affixed to the ground. A portion of the case is exposed with respect to the ground surface. An energy distributing shield is affixed to the exposed portion of the case.

In one example, the shield is made from open cell foam.

A method for seismic data acquisition according to another aspect of the invention includes affixing a plurality of spaced apart seismic sensors to the ground surface. Each of the seismic sensors includes a shield above an exposed portion of the sensor. The shield is made from an energy distributing material. At selected times a seismic energy source proximate the seismic sensors is actuated. Signals generated by each of the seismic sensors are recorded separately.

Other aspects and advantages of the invention will be apparent from the following description and the appended claims.

### BRIEF DESCRIPTION OF THE DRAWINGS

FIG. 1 shows a graphic representation of seismic data that was recorded using unshielded geophones in the absence of rain noise.

FIG. 2 shows seismic data recorded as in FIG. 1 with slight rain noise.

FIG. 3 shows seismic data recorded as in FIG. 2 with more rain noise than the data shown in FIG. 2.

FIGS. 4A and 4B show voltage waveforms of a test geophone to water droplets.

FIG. 5 shows one example of a shielded geophone according to the invention.

FIGS. 6A and 6B show voltage waveforms of a shielded test geophone in response to water droplets imparted to the test geophone.

FIG. 7 shows a seismic data recording system using sensors according to the invention.

### DETAILED DESCRIPTION

A typical geophone-type seismic energy detector is described in U.S. Pat. No. 6,645,004 issued to Mudge. A sensing element such as a geophone or accelerometer, or a plurality of such sensing elements, is disposed in a moisture resistant case or housing. The housing typically includes a spike or other extension on the lower end thereof to provide good contact with the ground. One or more cables laterally extend from the upper part of the housing to connect the sensing element to a recording device. The upper part of the housing is, however, typically exposed above the ground surface. Thus, in inclement weather, the upper part of the housing may be exposed rain drops. The impact of rain drops on the housing can be detected by the sensing element, inducing noise in the detected and recorded signals.

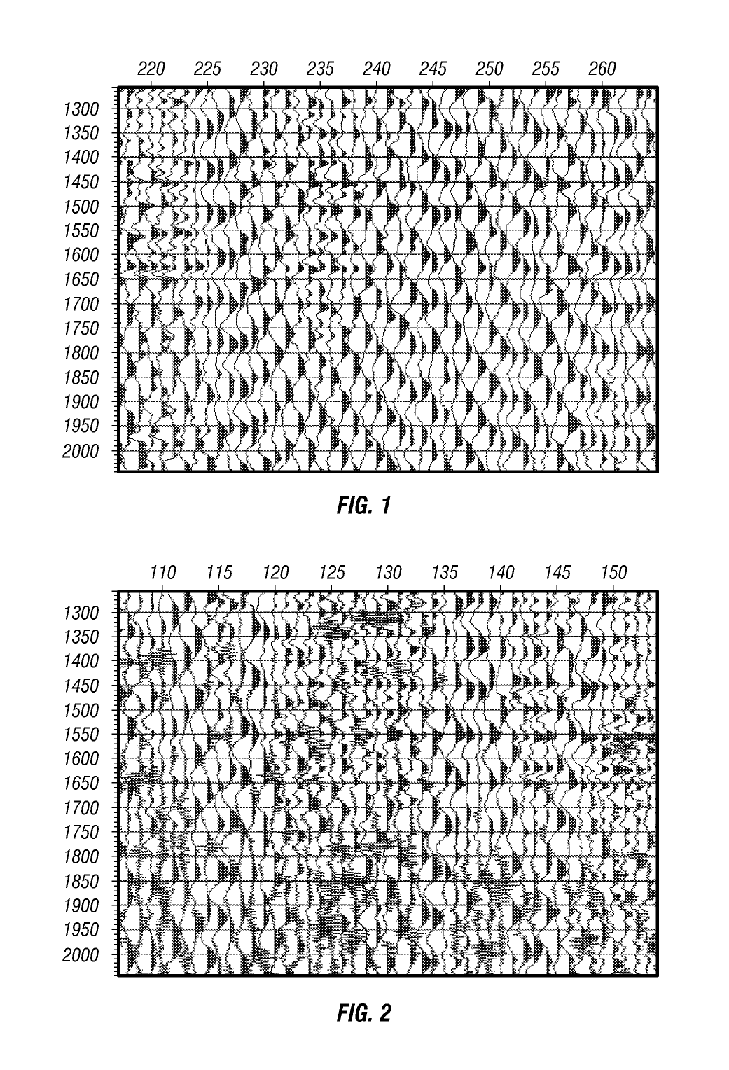

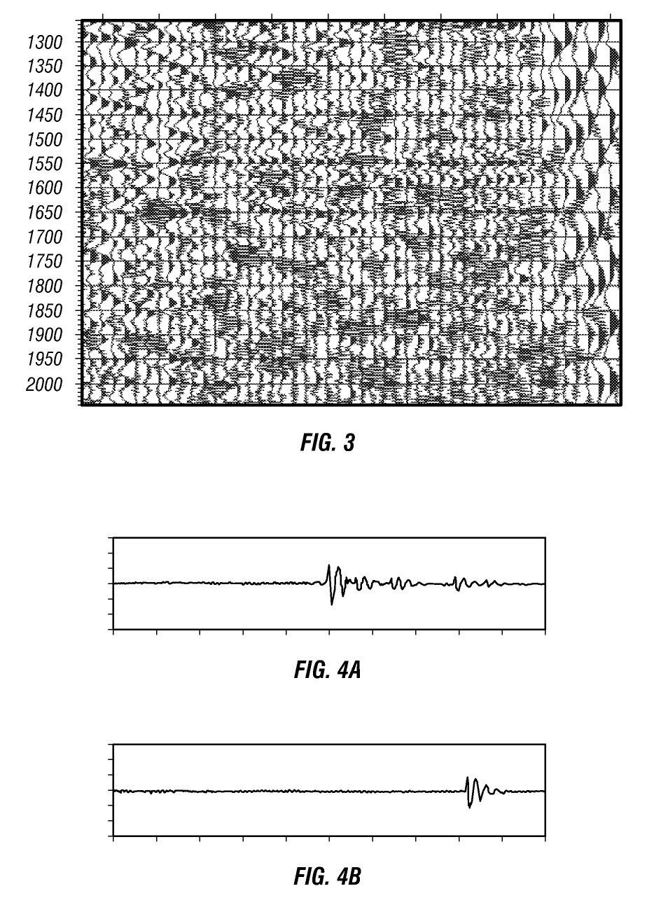

FIG. 1 shows seismic data as recorded using geophones that have essentially no noise induced by rain. The data are presented in the form of “wiggle traces” as will be familiar to those skilled in the art, that is in the form of amplitude curves with respect to time, with area between a fixed reference and the curve on one side of the reference being shaded or blackened. FIGS. 2 and 3 show, respectively, seismic data recorded using conventional, unshielded geophones in trace format as in FIG. 1, with slight (FIG. 2) and with moderate (FIG. 3) rain noise. The rain noise manifests itself as high frequency appearing features in the data traces. Spectral analysis of seismic data having rain noise confirms the nature of the noise in the data frequency spectrum. Increased high frequency content in the signal induced by rain noise can make extraction of higher frequency seismic data components in the signals more difficult.

To test a shielded seismic sensor according to the invention, a test fixture was produced wherein a single seismic sensor, for example, a geophone such as described in the Mudge '004 patent referenced above, was electrically connected to an oscilloscope, and the waveform of the signal output was monitored by observation of the oscilloscope. FIGS. 4A and 4B show waveforms of response of an unshielded geophone to water drops making impact with the geophone case.

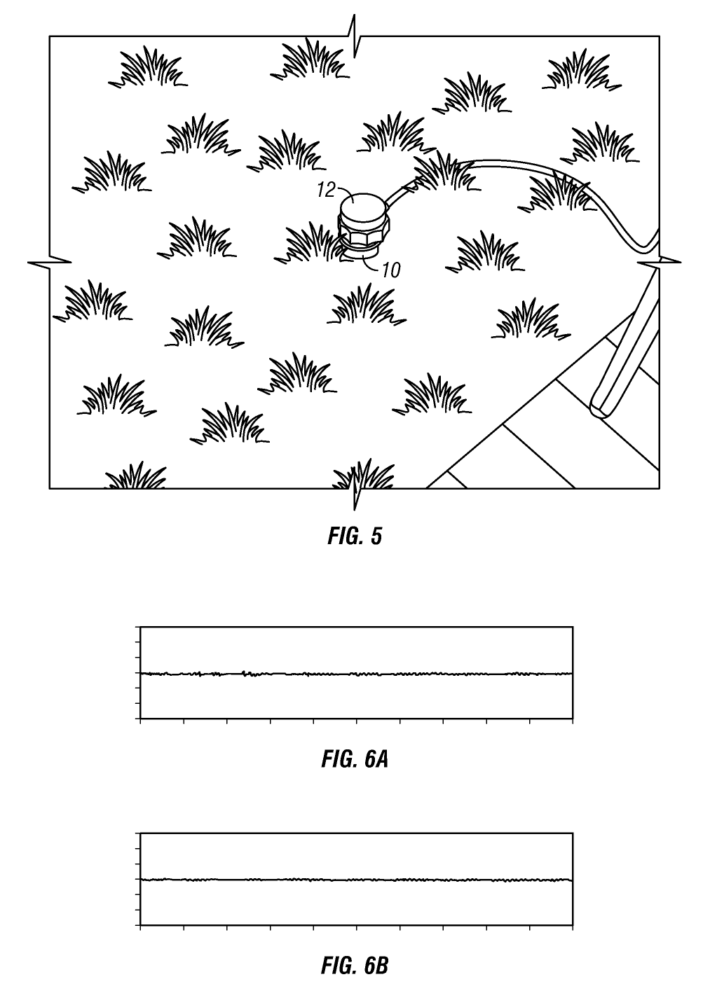

One example of a shielded seismic sensor according to the invention is shown in FIG. 5. A seismic sensor 10, which may be a geophone as explained above, is conventionally installed in the ground may include disposed on or affixed to the exposed (above ground) portion of its case a shield 12 made from an energy distributing material. In the present example, the shield 12 was made from open cell foam. Other materials may occur to those skilled in the art, but in principle, the material used to make the shield should have the property of distributing energy from impact. Foamed materials in general have such property if the base foamed material is relatively compressive.

Urethane foam, for example, may provide the advantage of being relatively immune to effects of the ambient environment, such as sunlight and corrosive materials in the atmosphere. By dispersing the energy from impact through the cells of the foam, the shield 12 dampens the effect of rain (in the form of drops or droplets) on the signals generated by the sensor 10. Other examples of energy distributing material include powdered cellulose, such as used in home insulation, loose glass fiber and shredded paper. However open cell foam, has the advantage that the water will slowly run through the foam and dissipate. Reticulated open cell foam may be used in other implementations.

The shield 12 in the present example was formed by making a right vertical cylinder from sheet foam to surround the exterior diameter of the geophone case, and affixing the cylinder directly to the exterior diameter of the case. A circle of about the diameter of the case was then made from sheet foam and disposed in the opening of the foam cylinder. Thus, most of the exposed portion of the geophone case was covered by a directly affixed layer of foam. Other configurations for the shield 12 will occur to those of ordinary skill in the art, including molding the shield to conform to the upper surface of the geophone case. Such shields may be easily installed and removed during deployment of an array of such geophones.

Response of the seismic sensor 10 having the shield 12 thereon to water drops as shown in FIG. 5 is shown graphically in FIGS. 6A and 6B. As may be inferred from FIGS. 6A and 6B, noise from water drops impacting the geophone case is substantially eliminated by the shield 12.

It is within the scope of this invention to provide a similar type of shield for other forms of seismic energy detectors, including without limitation accelerometers and other particle motion sensors. Any type of seismic sensor that is affected by rain noise may make use of a shield according to the invention.

A seismic sensor having a shield according to the invention may provide better quality seismic data in the presence of rain and other noise caused by impact or other environmental effects on the exposed case of a seismic sensor.

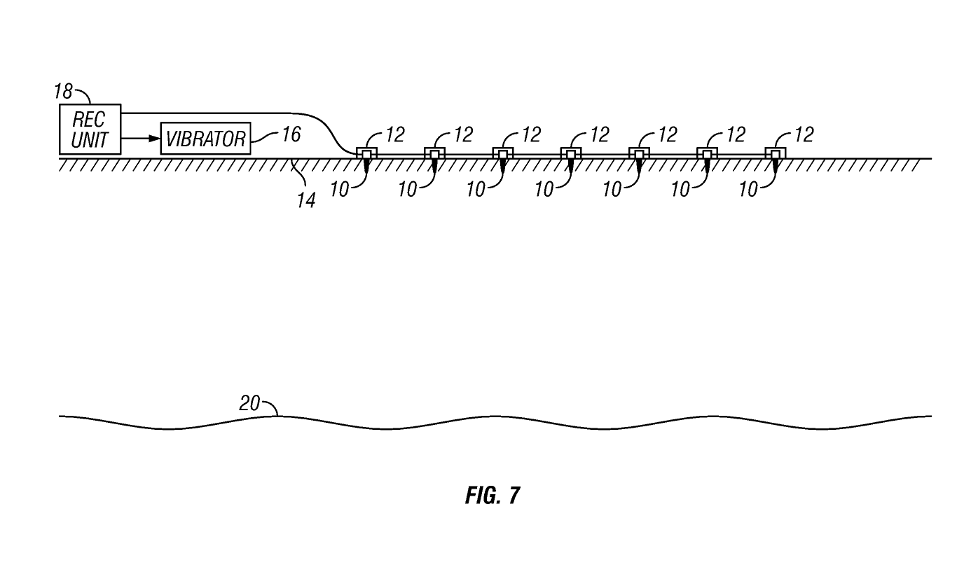

A seismic sensor made as explained above may be used advantageously in seismic data acquisition, and as will be explained with reference to FIG. 7. A plurality of seismic sensors 10 each including a shield 12 as explained above may be affixed to or near the ground surface 14. The seismic sensors 10 may be any type as explained above. The sensors 10 are in signal communication with a data recording unit 18 such that the signals from each sensor 10 may be recorded individually. At selected times, a seismic energy source 16, for example a vibrator, is actuated. Signals produced by the sensors 10 in response to seismic energy, for example, reflected from a subsurface acoustic impedance boundary 20, may be individually recorded in the recording unit 18. A method as in the foregoing example may provide better spatial resolution than recording techniques known in the art which use electrical summing of the signals from a plurality of adjacent seismic sensors to reduce the effects of random noise such as rain noise.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. While the invention is of particular applicability when the signal from a single geophone is recorded, it will also be of benefit if the signal from an array of geophones is recorded if the invention is deployed on each geophone of the array.

1. A seismic sensor, comprising:
a seismic energy detector having a case configured to be affixed to the ground, a portion of the case being configured to be exposed above the ground surface; and
an energy distributing shield formed from a material configured to dampen impact noise from rain affixed directly to the exposed portion of the case.

2. The sensor of claim 1 wherein the shield is formed from foam.

3. The sensor of claim 1 wherein the shield is formed from open cell foam.

4. The sensor of claim 1 wherein the shield is formed from reticulated open cell foam

5. The sensor of claim 1 wherein the shield if formed from foamed urethane.

6. The sensor of claim 1 wherein the shield is molded to conform to a shape of the exposed portion.

7. The sensor of claim 1 wherein the detector comprises a geophone.

8. The sensor of claim 1 wherein the detector comprises an accelerometer.

9. A method for seismic data acquisition, comprising:
affixing a plurality of spaced apart seismic sensors to the ground surface, each of the seismic sensors including a shield formed from a material configured to dampen impact noise from rain affixed directly to an exposed portion of the seismic sensors, the shield made from an energy distributing material;
at selected times actuating a seismic energy source proximate the seismic sensors; and
individually recording signals generated by each of the seismic sensors.

10. The method of claim 9 wherein the shield is formed from foam.

11. The method of claim 9 wherein the shield is formed from open cell foam.

12. The method of claim 9 wherein the shield is formed from reticulated open cell foam.

13. The method of claim 9 wherein the shield is formed from urethane foam.

14. The method of claim 9 wherein the shield is molded to conform to a shape of the exposed portion.

15. The method of claim 9 wherein the seismic sensors comprise geophones.

16. The method of claim 9 wherein the seismic sensors comprise accelerometers.
